(19) United States
(12) Patent Application Publication
(10) Pub. No.: US 2004/0222941 A1
(43) Pub. Date: Nov. 11, 2004

(54) Multi-display architecture using single video controller

(76) Inventors: Mark Yuk-Lun Wong, Union City, CA (US); Raymond Moon-Yeung Wong, Danville, CA (US); Thomas Tak Hung, Fremont, CA (US)

Correspondence Address: Debra A. Chun, 36 Sherland Avenue, Mountain View, CA, 94043, US

(21) Appl. No.: 10/750,440

(22) Filed: Dec. 30, 2003

Related U.S. Application Data
(60) Provisional application No. 60/437,704, filed on Dec. 30, 2002.

(51) Int. Cl. G09G 5/00

(52) U.S. Cl. 345/1.1

(57) ABSTRACT

A novel architecture for displaying images with multiple display devices uses only a single video display controller and single frame buffer regardless of how many display devices are included. The architecture can use a Time Division Multiplex Image Display (TDMID) algorithm for controlling the timing and data flow of the video display controller. The TDMID algorithm provides a simple way to send a divided image to different display devices by sharing line buffers, and thus eliminates the need for additional components as more display devices are added to a system. The novel architecture reduces overall system cost without sacrificing performance.

This application claims the benefit of provisional patent application Ser. No. 60/437,704 filed on Dec. 30, 2002, which is incorporated in its entirety herein by reference.

### BACKGROUND OF THE INVENTION

The present invention describes a novel architecture for displaying images with multiple visual display devices using only a single video display controller. The present invention overcomes disadvantages in prior art multi-display systems which requires one video display controller for each display device, as shown in FIG. 1. Additionally, the existing multi-display systems require multiple frame buffer architectures and extensive software overhead to segregate images and load them into the different frame buffers, which thus reduces overall system performance. Furthermore, in the prior art systems distinct image or video artifact occurs when the picture is displayed across the physical display boundary in both the x (horizontal arrangement) and y (vertical arrangement) directions.

### SUMMARY OF THE INVENTION

The present invention is directed at a multiple display architecture having a single video display controller. In one embodiment according to principles of the present invention, an M×N matrix display architecture includes M×N display devices, a single frame buffer and a single video display controller. The single video display controller can include M line buffer systems, where each of the line buffer systems have N line fetching systems and a data selector associated therewith. In an alternative embodiment the single video display controller can include M line buffer systems, where each of the line buffer systems have N line fetching systems and N data selectors associated therewith. The single video display controller can additionally include a Time Division Multiplex Image Display algorithm for controlling the timing and operation of the video display controller.

### BRIEF DESCRIPTION OF THE DRAWINGS

Other features and advantages of the invention, both as to its structure and its operation, will best be understood and appreciated by those of ordinary skill in the art upon consideration of the following detailed description and accompanying drawings of preferred embodiments, in which:

FIG. 1 illustrates a prior art multi-display architecture;

FIG. 2 illustrates a multi-display architecture according to principles of the present invention;

FIG. 3 illustrates a prior art circuit for implementing a 2×2 (M×N) display matrix video display controller;

FIG. 4 illustrates a line fetching system used in the circuit and algorithm shown in FIGS. 5 and 6;

FIG. 5 illustrates an embodiment for implementing a 2×2 (M×N) display matrix video display controller according to principles of the present invention;

FIG. 6 is an alternative embodiment for implementing a Time Division Multiplex Image Display (TDMID) algorithm video display controller in accordance with principles of the present invention;

FIG. 7 is a representation of a line buffer system used in the circuit and algorithm shown in FIGS. 5 and 6; and

FIG. 8 illustrates an alternative embodiment of a multi-display architecture according to the present invention which can be implemented for wireless applications.

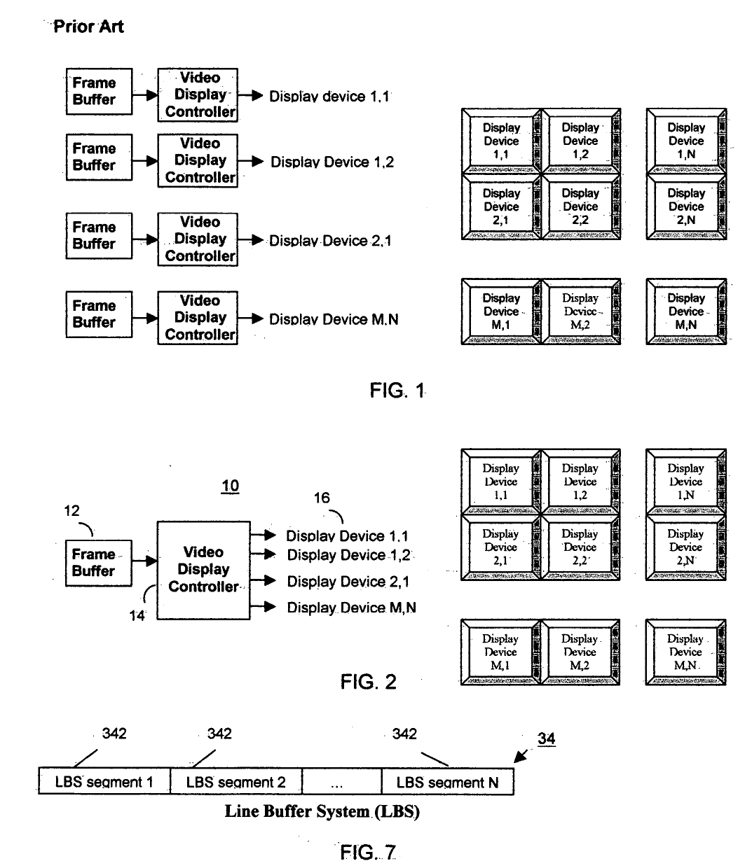

### DESCRIPTION OF THE INVENTION

Referring to FIG. 2, a simplified representation of the new multi-display architecture 10 in accordance with principles of the invention is shown. As seen in the figure, a single frame buffer 12 and video display controller 14 combination is employed to control the multiple display devices 16. In this first embodiment of the invention, the display devices are some type of LCD (liquid crystal display) type panel display device, plasma panel or organic LED (OLED) display. Current LCD types include but are not limited to TFT (Thin Film Transistor: active) displays and STN (Super Twisted Neumatics: passive) displays.

Using this type of arrangement several advantages can be achieved. As can be seen, the system requires only a single Video Display Controller 14 for all the LCD, Plasma or OLED panels. Also as noted above, only a single Frame Buffer 12 is used in this architecture. Prior art systems were not intelligent enough to maximize the available memory bandwidth by using memory burst read/write technique and therefore cannot use a single Frame Buffer 12 architecture. The present invention also minimizes visual artifact when the picture is displayed across display device boundaries in both x and y-directions (both horizontal and vertical arrangement). Previous generations of display technology had no concept of zooming up a small image to a large stern and therefore could not implement the architecture according to the present invention. Because the present invention does not require segregation and loading of images into different areas of the frame buffer, overall chip performance is improved. This in turns saves tremendous memory bandwidth. The present architecture can be implemented using System On Chip (SOC) design approaches which results in reduced system level design with minimal components. Additionally, the advance of semiconductor technology going into very deep sub-micron geometry aids in reducing the system level design. Thus, the overall system cost is minimized due to reducing additional

components used with each additional display device.

The architecture in accordance with the present invention can also be used in a multiple Cathode Ray Tube (CRT) or TV display environment. The architecture shown in FIG. 2 is again employed, where the display devices 16 are CRT or TV type displays. In this application of the invention, the same advantages are achieved as those described above with respect to the use of multiple panel type display devices.

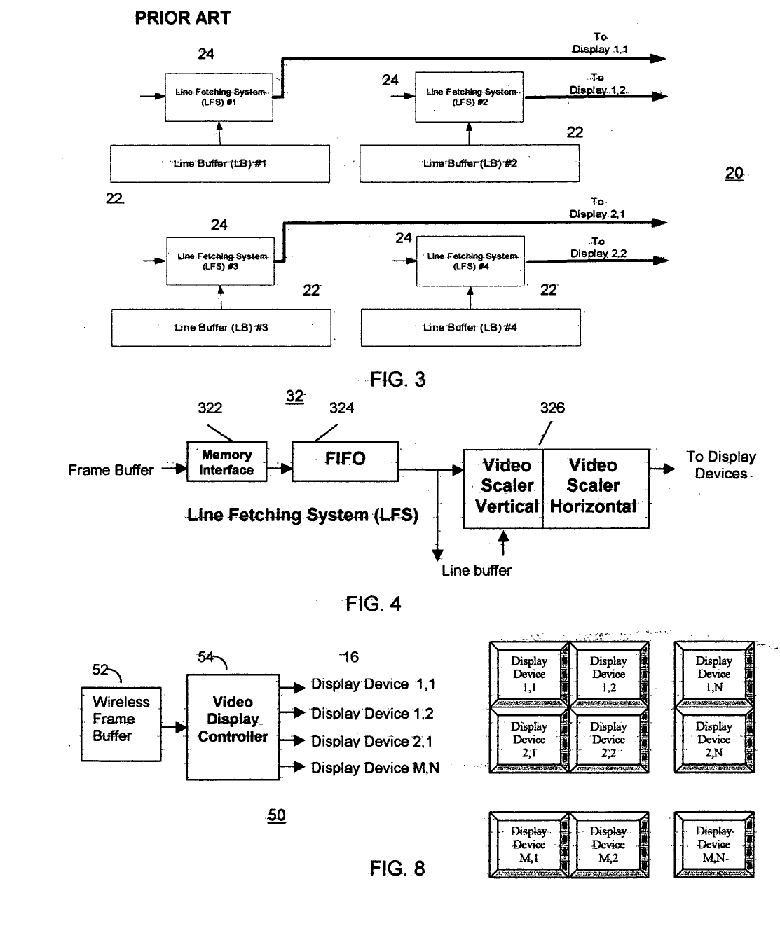

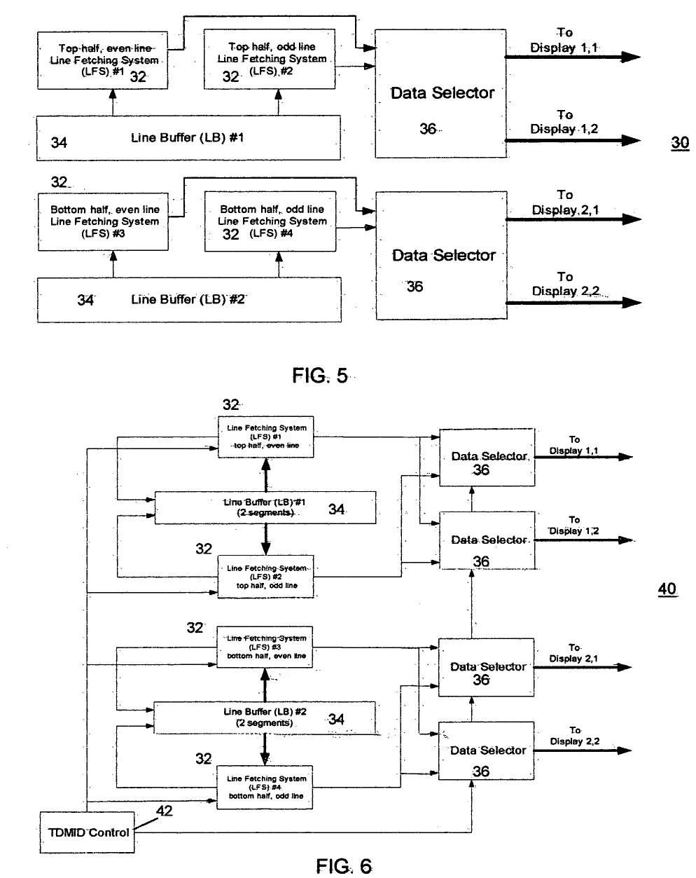

Now a novel circuit used in accordance with the present invention for implementing the single video controller 14 will be described. The circuit employs Line Buffers (LBs) for smoothly zooming-up images vertically in y-direction before sending the image data to the display devices 16. Each LB is an array of memory elements inside the chip and is used to store a portion of or the entire horizontal line of an image. The array is divided up into different segments which contain the image being displayed to each separate display device when ready. Referring to FIGS. 3 and 5, the prior art implementation required M×N LBs for an M×N display matrix, while the single video display controller according to the present invention requires only M LBs for the M×N display matrices. In both circuit designs, the size of the LBs can be the same. FIG. 3 illustrates the prior art circuitry 20 for a 2×2 (M×N) display matrix in accordance with the prior art implementation technique. As shown in FIG. 3, the prior art circuit 20 requires 4 (M×N=2×2=4) LBs 22 and 4 Line Fetching Systems (LFS) 24. In comparison, FIG. 5 illustrates the novel circuit 30 in accordance with the present invention, for a 2×2 (M×N) display matrix and requires only 2 (M=2) LBs 32.

Those of ordinary skill in the art can appreciate from the above example that certain advantages are provided by the circuit according to features of the present invention. As shown, the new circuit requires a lot less LBs (2 in current implementation verses 4 in prior art) which in turns saves a lot of area for other design blocks. For example, M×N display matrices, the new design requires M LBs while the prior art design uses M×N LBs. Additionally, since the new design uses less LBs, the overall frame buffer access is less than before. The completion of these accesses depends on how fast the frame buffers can respond The memory bandwidth is also dependent on the amount and response time of frame buffer accesses, and thus, the overall available memory bandwidth is increased substantially with the reduced frame buffer access. As a result, the system can run at a slower clock rate, dissipating less power while still maintaining the same image quality. The prior art design was more trivial and straightforward without worrying about the mechanics of control and de-multiplexing the output data to display devices but it required software overhead to separate and toad images into different frame buffers.

As seen in FIG. 5, the circuitry 30 for a video display controller in accordance with principles of the present invention includes multiple Line Fetching Systems (LFS) 32, 2 Line Buffer Systems (LBS) 34 and 2 Data Selectors (DS) 36. FIGS. 4 and 7 show exemplary LFS 32 and LBS 34 structures, respectively, that can be used in the present invention. The DS 36 can be a logic block that consists of logic and data registers allowing the image data to be sent to the display devices 16 in an orderly fashion complying with the display devices' requirement. Each DS 36 is controlled by the Time Division Multiplex Image Display (TDMID) algorithm, described herein below, to select which LFS 32 data to display.

Referring to FIG. 4, the LFS 32 consists of a Memory interface 322, a FIFO (First In First Out) storage element 324 and a Video Scaler 326. The Memory Interface 322 is used to fetch image data from the frame buffer 12. The FIFO 324 is used to store part of or the entire line of the image data. The scaler 326 consists of logic circuitry to convert the resolution (size) of the incoming image to fit the display device resolution (size). A scaler can reduce the image size or expand the incoming image size depending on the relative incoming image resolution (size) verses the outgoing desired display resolution (size). As seen in FIG. 4, in accordance with principles of the present invention, the scaler 326 includes a horizontal scaler portion and a vertical scaler portion. The horizontal scaler portion processes the image data within the same line, white the vertical scaler portion processes the image data across 2 or more line boundaries. The LFS 32 is employed to transport and process data from the frame buffer memory 12 and fine buffer to the display devices 16. It will also write the data from frame buffer 12 and store into line buffer for processing the next line. There are M×N LFS 32 for M×N display matrices. Each LFS 32 processes data in a line boundary and with hardware logic using the below described TDMID algorithm such that the display quality is guaranteed even when the line crosses the physical boundary from one display device to another display device in the horizontal direction.

Now, turning to FIG. 7, the LBS 34 includes a collection of data storage segments 342 for a dedicated display line type. For an M×N display matrix, there will be M LBS within the video display controller 14, where each LBS consists of N segments 342. Each segment supplies line data to the video scaler in the LFS 32 for vertical interpolation (mixing respective display pixels from different lines) as well as for getting new line data from the FIFO 324 of the LFS 32 as shown in FIG. 4.

Referring now to FIG. 6, another embodiment of a video display controller 40 for a M×N, in this case 2×2, display matrix, in accordance with principles of the present invention is shown. Here, a Time Division Multiplex Image Display (TDMID) algorithm 42 is used to control the timing and selection of image data to be displayed at the display devices 16. In addition to the TDMID algorithm 42, the video display controller 40 includes M horizontal display matrices, where each horizontal matrix includes a LB 34, N LFS 32 and N DS 36. The LB 34, LFS 32 and DS 36 can be implemented as described above.

The prior art implementation of a video display controller requires an independent horizontal scaler and independent vertical scaler for each of the display devices. Due to the independent nature of each of the respective scalers, there is significant image or video artifacts during the transition from one physical display boundary to another physical display boundary. Using a TDMID algorithm 42 however allows the same scaling engine to generate the scaled up image and time division multiplex out to different physical display devices. This allows a smooth image transition without any calculation intensive operation or table look-up technique to determine the correct scaling factors at the image boundary.

Another advantage of the TDMID implemented video display controller 50 is that a huge data bandwidth is saved. In a normal display pattern data is sent to the display devices one row at a time horizontally across. The more pixels that the video display controller has to scan the faster the required clock speed is. By using the TDMID algorithm 42, the operating clock speed does not change due to the expansion of the display device matrix (addition of display devices in the matrix). For example, the video display controller used in a 2×2 display matrix system operates at the same clock speed as that in a 4×4 display matrix system assuming the same type of display devices are used in each configuration. Each segment of the display devices operates at virtually the same time without waiting for the previous display device segment to finish. This reduction in operating frequency results in power savings and minimizes the FCC regulated Electro Migration lnterference (EMI) effect within the system.

By comparison, in the prior art implementation, a display matrix displaying an image resolution of 1980×1080 at 60 frames per second requires a clock speed of, or about, 160 MHz. When the same set of display devices operates at 72 frames per second to avoid visual flickering effect, it has to operate at a clock speed of, or about, 192 MHz. Another disadvantage of the prior art system is that a primitive timing controller is required to generate a primitive set of timing control parameters to control all the display devices. Each of the display devices has to use this same primitive set of timing control parameters at the same time. Thus, there could be no flexibility in the design. In comparison, the TDMID design set forth by the present invention allows for each display device to use the timing control parameters differently at different times, while still maintaining a simple timing controller design.

The Time Division Multiplex Image Display (TDMID) algorithm is a simple but orderly way to send the divided image to different displays devices so that it will share/eliminate hardware (i.e. line buffers). The TDMID algorithm 42 controls when to enable the Line Fetching Systems (LFS) 32 at different times to fetch image data and controls how the data from each LFS 32 are sent to the different display devices 16. For M×N display matrices, the TDMID hardware is divided into M identical horizontal display matrices. Each horizontal display matrix contains one line buffer 34 (divided into N segments), N Line Fetching System (LFS) 32, and N Data Selector (DS) 36 for each display devices. Each DS 36 is controlled by the TDMID 42 to select which LFS 32 data to display. By working with the TDMID 42, this DS 36 has more complicated logic to support the complexity of TDMID selection scheme as compared with the prior art implementation without the TDMID.

The TDMID algorithm 42 controls the timing and data flow to the display devices 16 in the following manner. At time t, the first LFS will fetch and send image data to the first display device. At the end of the display line of the first device at t+1 line, the first LFS will send image data to the second display device. At the end of the display line of the second device at t+2 line, the first LFS will send image data to the third display device, and so on until N display device. At time t+1 line+display blanking time, the second LFS will start processing the second line image data and send the data to the first display device. At time t+2 line+display blanking time, the second LFS will send the processed data to the second display device, and so on until N display device. At time t+2 line+display blanking time, the third LFS will start processing the third line image data and send the data to the first display device. At time t+3 line+display blanking time, the third LFS will send the processed data to the second display device, and so on until N display device. All the N LFS will use the same procedure for process N data lines. At time t+N line+display blanking time, the process will repeat with the first LFS.

The following tables illustrate the timing and data flow described, above for an exemplary 2×2 display matrix using the TDMID algorithm of the present invention. The total number of lines per image that will be displayed across all four display devices=2y. Each of the display devices will display ½ of the vertical lines and ½ of the horizontal portion of the image.

| | |
|---|---|
| Display 1, 1 | Display 1, 2 |
| Display 2, 1 | Display 2, 2 |

### 2×2 Display Device Matriv

### Tables Showing the Display Sequence of the 2×2 Display Device Matrix

| | Display 1, 1 | | Display 1, 2 |
|---|---|---|---|
| Time = t | Display Line # 1 | Time = t + 1 line − | No Display |
| | (from top, even LFS) | blanking time | |
| Time = t + 1 line | No Display | Time = t + 1 line | Display Line # 1 |
| | | | (from top, even LFS) |
| Time = t + 1 line + | Display Line # 2 | Time = t + 2 line | No Display |
| 1 blanking time | (from top, odd LFS) | | |
| Time = t + 2 line + | No display | Time = t + 2 line + | Display Line # 2 |
| blanking time | | blanking time | (from top, odd LFS) |
| Time = t + 2 line + | Display Line # 3 | Time = t + 3 line + | No Display |
| 2 blanking time | (from top, even LFS) | blanking time | |
| Time = t + 3 line + | No Display | Time = t + 3 line ++ | Display Line # 3 |
| 2 blanking time | | 2 blanking time | (from top, even LFS) |
| Time = t + 3 line + | Display Line # 4 | Time = t + 4 line + | No Display |
| 3 blanking time | (from top, odd LFS) | 2 blanking time | |
| Time = t + 4 line + | No Display | Time = t + 4 line + | Display Line # 4 |
| 3 blanking time | | 3 blanking time | (from top, odd LFS) |
| . . . | . . . | . . . | . . . |

| | Display 2, 1 | | Display 2, 2 |
|---|---|---|---|
| Time = t | Display Line # y + 1 | Time = t + 1 line − | No Display |
| | (from bottom, even LFS) | blanking time | |
| Time = t + 1 line | No Display | Time = t + 1 line | Display Line # y + 1 |
| | | | (from bottom, even LFS) |
| Time = t + 1 line + | Display Line # y + 2 | Time = t + 2 line | No Display |
| 1 blanking time | (from bottom, odd LFS) | | |
| Time = t + 2 line + | No display | Time = t + 2 line + | Display Line # y + 2 |
| blanking time | | blanking time | (from bottom, odd LFS) |
| Time = t + 2 line + | Display Line # y + 3 | Time = t + 3 line + | No Display |
| 2 blanking time | (from bottom, even LFS) | blanking time | |
| Time = t + 3 line + | No Display | Time = t + 3 line ++ | Display Line # y + 3 |
| 2 blanking time | | 2 blanking time | (from bottom, even LFS) |
| Time = t + 3 line + | Display Line # y + 4 | Time = t + 4 line + | No Display |
| 3 blanking time | (from bottom, odd LFS) | 2 blanking time | |
| Time = t + 4 line + | No Display | Time = t + 4 line + | Display Line # y + 4 |
| 3 blanking time | | 3 blanking time | (from bottom, odd LFS) |
| . . . | . . . | . . . | . . . |

Another aspect of the multi-display, single display controller architecture of the present invention is using removable and interchangeable storage elements as frame buffers. Here, users select the appropriate storage medium for their image or video content. Thus, users can choose whichever available storage media at the time for the sake of cost, size and availability of the media. The prior art implementation uses fixed memory elements such as memory IC for the ease of design. In accordance with the present invention, the frame buffer size can increase indefinitely which means unlimited amount of image or video content can be accessed and displayed on the display devices. In comparison, the prior art implementation has a fixed amount of memory storage because previous designers assume the image size is fixed. In real life, however, image size can vary dramatically such as the image size from a 3.0 Mega Pixel Camera is 3 times that of a 1.0 Mega Pixel camera.

Other advantages can be achieved by using removable and interchangeable storage media as the frame buffers. For instance, the storage media can be preloaded with user image or video, which can be accessed and displayed automatically by the Video Controller periodically without any user interaction. Additionally, using such an implementation, the frame buffer can be a totally integrated system and can be a standalone portable solution such as in a PDA application. Again, as discussed above, the number of additional components is reduced, thus minimizing the overall system cost.

A still further alternative embodiment of a multi-display, single video controller architecture 50 can be seen in FIG. 8, where a wireless interface device 52 is employed for the frame buffer. As in the case with the removable or interchangeable storage media, users can select an appropriate wireless interface device 52 for their image or video content. This approach allows the device to fetch data from a wireless system and acts as an initiator as opposed to being a receiver like the TV display. This allows any up-to-date image and video content to be accessed and displayed in real time, and no preloading, of any image or video content is necessary. Additionally, image or video content can be stored in the Wireless Interface Device 52 for repeated display to the displayed devices. In this embodiment, the multi-display architecture 50 also includes a single video display controller 54 for controlling the multiple display devices 16. The single video display controller 54 can be implemented using the circuits described above with respect to FIGS. 5 or 6.

Using a wireless interface device for the frame buffer has many of the same advantages as those discussed above with respect to the removable and interchangeable storage media frame buffers. As in the above embodiment, the frame buffer size can be infinite Which means an unlimited amount of image or video content can be accessed and displayed on the display devices, user image or video which can be accessed and displayed automatically by the video controller periodically without any user interaction, the wireless interface device can be a totally integrated system and a standalone portable solution and, as in the other embodiments described hereinabove, the overall system cost is minimized by reducing the amount of additional components.

Having thus described various embodiments of the invention, it will now be understood by those skilled in the art that many changes in construction and circuitry and widely differing embodiments and applications of the invention will suggest themselves without departure from the spirit and scope of the invention. The disclosures and the description herein are purely illustrative and are not intended to be in any sense limiting. Rather, the invention is to cover all modifications, equivalents, and alternatives falling within the spirit and scope of the invention as defined by the appended claims.

What is claimed is:

1. A M×N matrix display architecture comprising:
M×N display devices;
one video display controller and
one frame buffer,
wherein only the one frame buffer and the one video display controller are required to control timing and flow of image data to the M×N display devices.

2. The display architecture of claim 1 wherein the one video display controller comprises:
M line buffer systems for receiving image data from the frame buffer;
N line fetching systems associated with each line buffer system for fetching and processing image data from its associated line buffer system and
a data selector associated with each line buffer system for selecting the image data from one of the line fetching systems and sending the image data to one of the display devices.

3. The display architecture of claim 2 wherein each line buffer system comprises N line buffer segments storing image data to be sent to the line fetching systems.

4. The display architecture of claim 3 wherein each line fetching system comprises:
a memory interface receiving image data from the frame buffer;
a First-In-First-Out (FIFO) memory unit, and
a scaler unit for scaling image data received from the FIFO memory unit or image data received from the line buffer system.

5. The display architecture of claim 4 further comprising a Time Division Multiplex Image Display (TDMID) algorithm for determining which line fetching system the data selector sends image data from and for controlling the timing for sending the image data.

6. The display architecture of claim 1 wherein the video display controller comprises:
M line buffer systems;
N line fetching systems associated with each line buffer system;
N data selectors associated with each line buffer system, and
a Time Division Multiplex image Display (TDMID) algorithm for controlling the timing and data flow of the video display controller.

7. The display architecture of clam 6 wherein each line buffer system comprises N line buffer segments storing image data to be sent to the line fetching systems.

8. The display architecture of claim 7 wherein each line fetching system comprises:
a memory interface receiving image data from the frame buffer;
a First-In-First-Out (FIFO) memory unit, and
a scaler unit for scaling image data received from the FIFO memory unit or image data received from the line buffer system.

9. The display architecture of claim 8 wherein the scaler unit comprises a horizontal scaler portion and a vertical scaler portion.

10. An M×N matrix display architecture comprising:
M×N display devices;
a frame buffer, and
a video display controller comprising
M line buffer systems for receiving image data from the frame buffer,
N line fetching systems associated with each fine buffer system for fetching and processing image data from its associated line buffer system,
a data selector associated with each line buffer system for selecting the image data from one of the line fetching systems and sending the image data to one of the display devices and
a Time Division Multiplex Image Display (TDMID) algorithm for controlling the timing and operation of the data selector, wherein only a single frame buffer and single video display controller combination are required to control timing and flow of image data to the M×N display devices.
